(19) United States
(12) Patent Application Publication
(10) Pub. No.: US 2007/0076114 A1
(43) Pub. Date: Apr. 5, 2007

(54) Digital camera module with a positon tracking device

(75) Inventor: Kun-Jung Tsai, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/416,553

(22) Filed: May 3, 2006

(30) Foreign Application Priority Data
Sep. 30, 2005 (CN) 200510100097.4

(51) Int. Cl. G02B 13/16

(52) U.S. Cl. 348/335

(57) ABSTRACT

A digital camera module (100) for a portable electronic device, includes a lens holder (20), a lens module (10) axially movably received in the lens holder and at least one position tracking device (30). Each position tracking device includes a resistor (33) secured to the holder, a probe (31) attached to the lens module and slidably contacting with the resistor, and a measuring unit (35) electrically connecting with the resistor and the probe therebetween in series for measuring a resistance value of the resistor as it changes with the movement of the lens module thus enabling it to detect the position of the lens module.

### BACKGROUND OF THE INVENTION

1. Field of the Invention

The present invention relates generally to digital camera modules, and more particularly to a digital camera module which integrates a position tracking device for tracking a real-time position of a lens module.

2. Discussion of the Related Art

Nowadays, digital cameras with an automatic focus (AF) function are widely used. The AF apparatus works by detecting the focusing state of an image-taking lens to find a defocus amount (i.e. the distance by which the camera is out of focus), calculating a movement amount of a focus lens corresponding to the defocus amount, and driving the focus lens to move. However, there is a risk that an actual movement amount of the focus lens driven to move will not be the same as the target movement amount and the focusing accuracy of the digital camera will be affected as a result.

What is needed, therefore, is a digital camera module with position tracking device which tracks a real-time position of a lens module for improving focusing accuracy.

### SUMMARY OF THE INVENTION

In one aspect, a digital camera module for a portable electronic device includes a lens holder, a lens module axially movably received in the lens holder and at least one position tracking device. Each position tracking device includes a resistor secured to the holder, a probe attached to the lens module and slidably contacting with the resistor, and a measuring unit electrically connecting with the resistor and the probe therebetween in series for measuring a resistance value of the resistor as it changes with the movement of the lens module thus enabling it to detect the position of the lens module.

Other advantages and novel features will become more apparent from the following detailed description of preferred embodiment when taken in conjunction with the accompanying drawings, in which:

### BRIEF DESCRIPTION OF THE DRAWINGS

Many aspects of the present digital camera module with a position tracking device can be better understood with reference to the following drawings. The components in the drawings are not necessarily drawn to scale, the emphasis instead being placed upon clearly illustrating the principles of the digital camera module with a position tracking device. Moreover, in the drawings, like reference numerals designate corresponding parts throughout the several views.

FIG. 1 is a schematic, exploded, isometric view of a digital camera module in accordance with a preferred embodiment, without showing a measuring unit; and

FIG. 2 is an assembled, cross-sectional view of FIG. 1, but showing the measuring unit.

### DETAILED DESCRIPTION OF THE PREFERRED EMBODIMENT

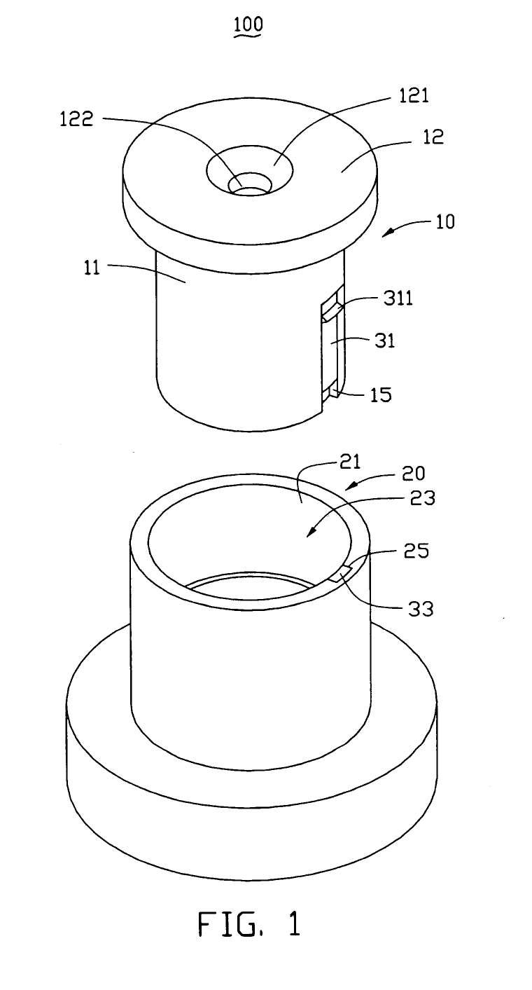

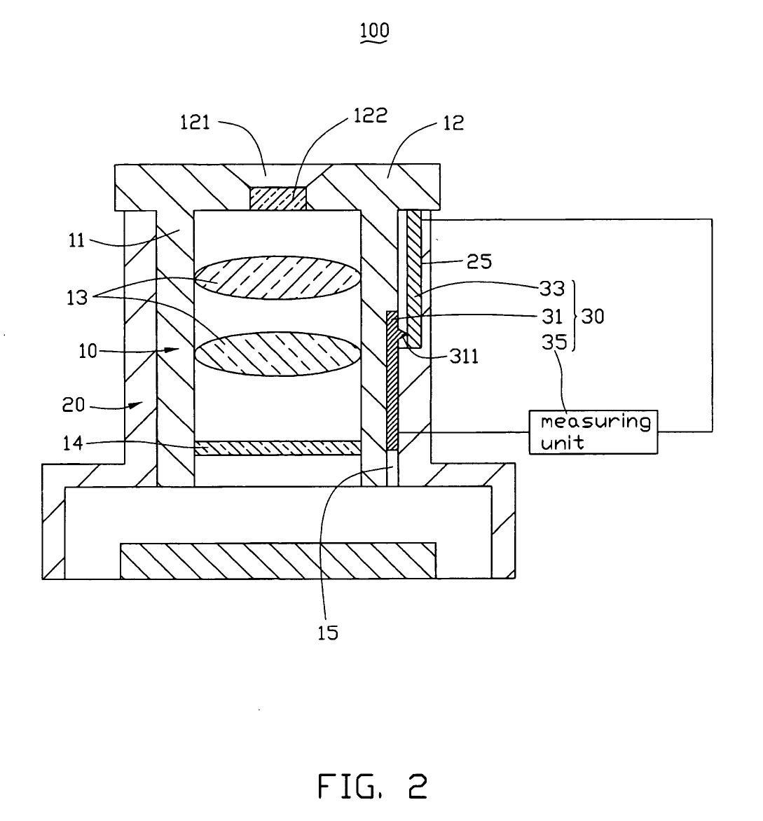

The digital camera module with a position tracking device of the present invention is suitable to use in portable electronic devices, such as cameras, mobile phones, personal digital assistants (PDA), palm computers and so on, which can contain a digital camera module having an AF function therein. Referring to FIG. 1 and FIG. 2, a digital camera module 100 according to a preferred embodiment includes a lens module 10, a lens holder 20 and a position tracking device 30. The lens module 10 is received in the lens holder 20 and can be driven to move axially in the lens holder 20. The position tracking device 30 is used to detect a position of the lens module 10 received in the lens holder 20.

The lens module 10 includes a lens barrel 11, a lens group 13 and an infrared-cut filter (IR-cut filter) 14. The lens barrel 11 has a first half-opening end 12 and a second opening end (not labeled) opposite to the first end 12. The lens barrel 11 has a groove 15 defined in an outer peripheral surface (not labeled) of the barrel 11, axially extending from the second end to the first end 12. In a central portion of the first end 12, there is a window 121 for transmitting light beams into the lens barrel 11. The window 12 includes a transparent board 122 embedded therein, in order to seal the first end 12, and protect the lens group 13 from dust and/or particle pollution/contamination. It is to be understood that, a focus lens could be embedded in the window 121 instead of the transparent board 122. The focus lens can converge external light beams into the lens barrel 11 while preventing dust and/or particle pollution/contamination.

The lens holder 20, which is a cylinder in shape, includes an inner surface 21 and a receiving chamber 23 defined therein. The inner surface 21 peripherally surrounds the receiving chamber 23, and has a slot 25 defined therein. The slot 25 communicates with the receiving chamber 23, and corresponds to the groove 15 of the barrel 11. The receiving chamber 23 is used to receive the barrel 11 of the lens module 10, and has a profile slightly larger than that of the barrel 11.

The position tracking device 30 includes a probe 31, a resistor 33, a measuring unit 35 and a controlling unit (not shown). The probe 31 is made from electric conducting material, and has a pin 311 projecting therefrom. The probe 31 is embedded in and fixed to the groove 15 of the barrel 11, with the pin 311 extending out of the groove 15. The resistor 33 is received in the slot 25 and fixed to the lens holder 20. The measuring unit 35, such as an ohmmeter, electrically connects with the probe 31 and one end of the resistor 33 therebetween in series. The lens module 10 is received in the receiving chamber 23 of the holder 20, and the pin 311 of the probe 31 electrically contacts with the resistor 33. Therefore, the measuring unit 35 measures a resistance value of the resistor 33 between a contact position where the pin 311 contacts with the resistor 33 and the end of the resistor 33 electrically connecting with the measuring unit 35, which is in association with the movement of the lens module 10 to detect the position of the lens module 10 received in the lens holder 20. The measuring unit 35 outputs a signal with the resistance value corresponding to the position of the lens module 10. The controlling unit electrically connects with the measuring unit 35 and receives the signal with the resistance value. The controlling unit calculates the position of the lens module 10 received in the lens holder 20 from the resistance value transmitted from the measuring unit 35.

In use of the digital camera module 100, which is integrated into a portable electronic device, the measuring unit 35 is electrically connected with a power source such as a battery of the portable electronic device in order to supply electrical power. The controlling unit could be a micro controller unit (MCU) of the portable electronic device. When the digital camera module 100 needs to AF, the lens module 10 is driven by an actuator, such as a step motor integrated in the electronic portable device, to axially move in the lens holder 20. The contact position jointly changes, and the resistance value of the resistor 33 between the contact position and said end of the resistor 33 changes in response to the movement of the lens module 10. The controlling unit receives the continuously varied signal with the resistance value from the measuring unit 35 and calculates the position of the lens module 10 deriving on the resistance value. Therefore, in this manner the tracking of the position of the lens module 10 received in the lens holder 20 is achieved. If the actual movement amount of the lens module 10, which is calculated by the controlling unit deriving on the signal output from position tracking device 30, is unequal to the target movement amount of the lens module 10, the controlling unit triggers the actuator to drive the lens module 10 until the actual movement amount of the lens module 10 is equal to the target movement amount.

It is to be understood that the position tracking device 30 could include multiple groups of the probe 31, the resistor 33 and the measuring unit 35. The probes 31 can be axially mounted to the lens barrel 11 and spaced from each other. The resistors 33 can be mounted to the lens holder 20, each resistor 33 contacting with a probe 31. Each measuring unit 35 can electrically connect with a corresponding probe 31 and a corresponding resistor 33. The controlling unit electrically connects with the measuring units 35 of each group, and compares the resistance values simultaneously transmitted from the measuring units 35 to estimate whether the lens barrel 11 moves axially or deviates from the axis.

It is believed that the present embodiments and their advantages will be understood From the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A digital camera module comprising:
a lens holder;
a lens module axially movably received in the lens holder; and
at least one position tracking device, each position tracking device comprising:
a resistor secured to the lens holder;
a probe attached to the lens module and slidably contacting with the resistor;
a measuring unit electrically connecting with the resistor and the probe therebetween in series for measuring a resistance value of the resistor as it changes with the movement of the lens module thus enabling it to detect the position of the lens module.

2. The digital camera module as claimed in claim 1, wherein the lens module comprises a barrel and at least one lens received in the barrel, the barrel has at least one groove defined in a peripheral surface thereof, each groove respectively receiving a corresponding probe therein.

3. The digital camera module as claimed in claim 1, wherein the lens holder is a hollow cylinder in shape, and has at least one slot defined on an inner peripheral surface thereof, each slot respectively receiving a corresponding resistor therein.

4. The digital camera module as claimed in claim 2, wherein the probe comprises a pin projecting therefrom, the pin contacts with the resistor.

5. The digital camera module as claimed in claim 1, wherein each probe contacts with a resistor at a contacting position, each contacting position changes in response to the movement of the lens module.

6. The digital camera module as claimed in claim 5, wherein each measuring unit electrically connects with an end of a corresponding resistor, and measures the resistance value of the corresponding resistor between the contacting position and the end.

7. The digital camera module as claimed in claim 1, wherein each measuring unit outputs a signal corresponding to the resistance value.

8. The digital camera module as claimed in claim 7, wherein the digital camera module further comprises a controlling unit electrically connecting with each measuring unit, the controlling unit receives the signal with the resistance value output from each measuring unit and calculates the position of the lens module derived on the signal.

9. The digital camera module as claimed in claim 1, wherein the measuring unit is an ohmmeter.

10. A digital camera module comprising:
a lens holder;
a lens module axially movably received in the lens holder; and
a position tracking device, the position tracking device comprising a resistor, a probe and a measuring unit, one of the resistor and the probe being attached to the lens holder and the other being attached to the lens module, the resistor and the probe slidably contacting with each other, the measuring unit electrically connecting with the resistor and the probe in series so as to form a loop, the measuring unit being configured for measuring a resistance value of the resistor as it changes with movement of the lens module thus enabling it to detect the position of the lens module.

11. The digital camera module as claimed in claim 10, wherein the probe comprises a pin projecting therefrom, and the pin slidingly contacts the resistor as the lens module moves relative to the lens holder.
